(19) United States
(12) Patent Application Publication
(10) Pub. No.: US 2026/0281776 A1
(43) Pub. Date: Sep. 17, 2026

(54) TECHNIQUES FOR REPORTING CHANNEL STATE INFORMATION

(71) Applicant: ZTE CORPORATION, Shenzhen (CN)

(72) Inventors: Xiaoying MA, Shenzhen (CN); Mengzhu CHEN, Shenzhen (CN); Jun XU, Shenzhen (CN); Bo DAI, Shenzhen (CN); Hong TANG, Shenzhen (CN); Xuan MA, Shenzhen (CN)

(21) Appl. No.: 19/471,490

(22) PCT Filed: Apr. 7, 2023
(86) PCT No.: PCT/CN2023/087129

§ 371 Date: Oct. 1, 2025

(51) Int. Cl. H04W 24/10

(52) U.S. Cl. CPC H04W 24/10

(57) ABSTRACT

A device receives a control signaling that includes one or more channel state information (CSI) report configurations associated with one or more reference signal (RS) resources. The device receives a first signaling. The device transmits, to a network node, one or more CSI reports according to the first signaling and the one or more CSI report configurations.

### CROSS-REFERENCE TO RELATED APPLICATION

This application is a national stage filing under 35 U.S.C. § 371 of international application number PCT/CN2023/087129 filed Apr. 7, 2023, the contents of which are incorporated herein by reference in its entirety.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

This document provides techniques for reporting and configuring channel state information (CSI) in wireless communications systems.

In some aspects, the techniques described herein relate to a method of wireless communication including: receiving, by a wireless device, a control signaling that includes one or more channel state information (CSI) report configurations associated with one or more reference signal (RS) resources; receiving, by the wireless device, a first signaling; and transmitting, to a network node, one or more CSI reports according to the first signaling and the one or more CSI report configurations.

In some aspects, the techniques described herein relate to a method of wireless communication including: transmitting, by a network node, a control signaling that includes one or more channel state information (CSI) report configurations associated with one or more reference signal (RS) resources; transmitting, by the network node, a first signaling; and receiving, from a wireless device, one or more CSI reports according to the first signaling and the one or more CSI report configurations.

In other aspects, the above-described methods are embodied in the form of processor-executable code and stored in a computer-readable program medium.

In yet other aspects, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example of a wireless communication system based on some example embodiments of the disclosed technology.

FIG. 2 shows an example port selection, in accordance with embodiments of the present disclosure.

FIG. 3 shows an example port selection, in accordance with embodiments of the present disclosure.

FIG. 4 shows an example port selection, in accordance with embodiments of the present disclosure.

FIG. 5 shows an example selection of an antenna muting pattern, in accordance with embodiments of the present disclosure.

FIG. 6 shows an example bitmap indication, in accordance with embodiments of the present disclosure.

FIG. 7 shows an example pattern set indication, in accordance with embodiments of the present disclosure.

FIG. 8 is a flow diagram illustrating an example process for wireless communication, in accordance with embodiments of the present disclosure.

FIG. 9 is a flow diagram illustrating an example process for wireless communication, in accordance with embodiments of the present disclosure.

FIG. 10 is a block diagram representation of a portion of an apparatus based on some embodiments of the disclosed technology.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

Wide bandwidth, multi-antenna systems are increasing being used in telecommunications. As the number of spatial elements increases, so does power consumption. To reduce the power consumption of the network (e.g., gNodeB (gNB)), one method is reducing the number of antennas or antenna ports. As a result, channel properties change as the number of antennas change. To help the network obtain the channel states of different numbers of antennas, multiple channel state information (CSI) with different antenna patterns are needed. The multiple CSIs corresponding to different antenna patterns can be obtained by a specific CSI report configuration type. However, overhead is large if user equipment (UE) is required to report multiple CSIs. To address these issues, techniques described in this patent can dynamically change the number of CSI reports reported in one or multiple CSI reportings, reducing overhead and UE complexity.

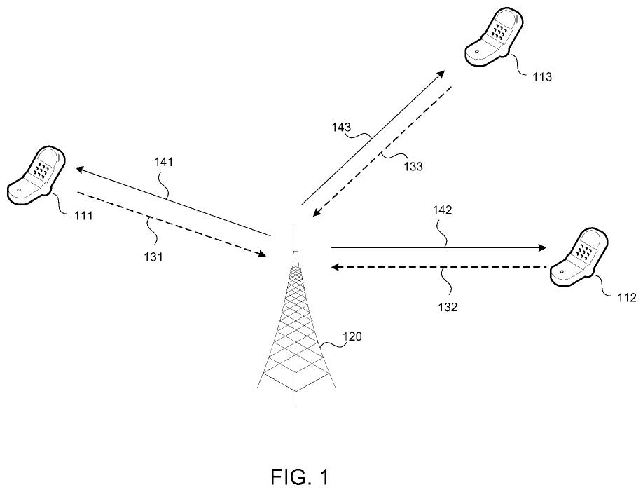

FIG. 1 shows an example of a wireless communication system (e.g., a long term evolution (LTE), 5G or NR cellular network) that includes a BS 120 and one or more user equipment (UE) 111, 112 and 113. In some embodiments, the uplink (UL) transmissions (131, 132, 133) can include uplink control information (UCI), higher layer signaling (e.g., UE assistance information or UE capability), or uplink information. In some embodiments, the downlink (DL) transmissions (141, 142, 143) can include Downlink Control Information (DCI) or high layer signaling or downlink information. The UE may be, for example, a smartphone, a tablet, a mobile computer, a machine to machine (M2M) device, a terminal, a mobile device, an Internet of Things (IoT) device, and so on.

The UEs 111, 112, or 113 can perform CSI measurements based on a CSI reference signal (CSI-RS) and can report corresponding report to the BS 120. The UEs 111-113 can be configured with one or more CSI report configuration by CSI-ReportConfig signaling. The CSI-ReportConfig is associated with one or more CSI-RS resource settings by CSI-resourceConfigID. The CSI-RS resource setting is configured by CSI-ResourceConfig signaling.

The number of ports of a CSI-RS is configured by nrofPorts in CSI-ResourceMapping, CSI-ResourceMapping is associated with a NZP-CSI-RS-Resource. NZP-CSI-RS-Resource is associated with a NZP-CSI-RS-ResourceSet. A NZP-CSI-RS-ResourceSet is associated with a CSI-ResourceConfig. A CSI-ResourceConfig is associated with a CSI-ReportConfig. The nrofPorts can be one of the following: p1, p2, p4, p8, p12, p16, p24, or p32. For example, p1 can refer to 1 port.

### Reporting Framework

To perform a CSI report, a UE (e.g., UE 111-113) first receives a control signaling, such as radio resource control (RRC) signaling from a network node (e.g., BS 120). The RRC signaling includes one or more CSI report configurations, including a first CSI report configuration. The UE receives a first signaling. Finally, the UE performs a CSI report according to the first signaling and the one or more CSI report configurations.

The first CSI report configuration can satisfy at least one of the following conditions:
A CSI report configuration is associated with one CSI-RS resource. The UE can use part or all of the ports associated with the CSI-RS resource for a CSI report calculation, and report one CSI report for the CSI report configuration,
A CSI report configuration is associated with one CSI-RS resource. The UE uses a configured power offset or an indicated power offset(s) for a CSI report calculation, and report one or more CSI reports for the CSI report configuration.
A CSI report configuration is associates with one CSI-RS resource. The UE uses part or all of the ports associated with the CSI-RS resource for a CSI report calculation, and report multiple CSI reports for the CSI report configuration.
A CSI report configuration is associated with a CSI-RS resource configured with multiple different resource parameters. The UE reports one or more CSI reports according to one or more of the resource parameters for the CSI report configuration. In some embodiments, each resource parameter corresponds to one resource mapping (e.g., a parameter resourceMapping), one resource, one resource set, or one resource setting. For example, A CSI report configuration can be associated with multiple CSI-RS resources configured with multiple different resource parameters. Different CSI-RS resources can be configured with different resource parameters. For example, different resource parameters can mean that at least one of the resource parameters is different.
A CSI report configuration is associated with multiple PUCCH resource parameter sets. The UE reports multiple CSI reports according to different PUCCH resource parameter sets. The PUCCH resource parameter sets include at least one of the following: periodicity and offset of a reporting configuration for periodic and semi-persistent CSI report, a PUCCH resource list of a reporting configuration for CSI reported on PUCCH, a report slot offset list of a reporting configuration for CSI reported on PUSCH, or a reportConfigType.

In some embodiments, a CSI-RS resource is at least one of the following: a resource (e.g., configured by NZP-CSI-RS-Resource), a ResourceMapping, a resource set (e.g., configured by NZP-CSI-RS-ResourceSet), a resource setting (e.g., configured by CSI-ResourceConfig).

Resource parameters include at least one of the following: number of ports, port indices indication, power offset, an index (e.g., a CRI (CSI-RS Resource Indicator), a resource ID, a resource set ID, a resource setting ID), a transmission configuration indication (TCI), code division multiplexing (CDM) type, resource mapping, CDM group index, frequency domain resource, time domain resource, or a group index.

In some embodiments, power offset corresponds to a parameter powerControlOffset or powerControlOffsetSS. Number of ports means a number of CSI-RS ports, e.g., 2, 4, 8, 16, 32, etc.

powerControlOffset refers to the assumed ratio of a Physical Downlink Shared Channel (PDSCH) energy per resource element (EPRE) to non-zero power (NZP) CSI-RS EPRE when the UE derives CSI feedback. powerControlOffset can take values in the range of [−8, 15] dB, with 1 dB step size.

powerControlOffsetSS refers to the assumed ratio of NZP CSI-RS EPRE to synchronization signal/physical broadcast channel (SS/PBCH) block EPRE.

In some embodiments, the CSI report configuration corresponds to a CSI-ReportConfig configured by RRC signaling.

### First Signaling

As previously described, the UE can be configured with a first CSI report configuration, where the first CSI report configuration is associated with one CSI-RS resource, one number of ports, or one or more antenna muting patterns. The UE receives a first signaling and reports one or multiple CSI reports in one reporting instance based on the first CSI report configuration and/or a first signaling.

In some embodiments, the first signaling indicates a port selection, a power offset selection, or a resource parameter selection. Information indicating the port selection, power offset selection, or resource parameter selection can include at least one of the following: a bitmap indication, a port index set indication, an indication of a number of ports, a set {N1, N2}, a scaling factor, a codebook configuration, or an antenna muting pattern. In other words, the first signaling can indicate at least one of the following information: a bitmap indication, a port index set indication, an indication of a number of ports, a set {N1, N2}, a scaling factor, or an antenna muting pattern.

In some embodiments, the first signaling is one of: a DCI, MAC CE, or RRC signaling.

The codebook configuration can include at least one of: a codebook (e.g., configured by CodebookConfig), a codebook type, a codebook subset restriction, or a RI restriction.

In some embodiments, the first CSI report configuration is configured with multiple codebook configurations. Each codebook configuration is associated with one antenna muting pattern, one resource parameter, one {N1,N2}, one PUCCH resource, or one bitmap.

In some embodiments, when a first signaling indicates one or more antenna muting patterns, one or more resource parameters, one or more {N1,N2}, one or more PUCCH resource, or one or more bitmap, the associated codebook configuration(s) are also indicated.

In some embodiments, the first signaling is a DCI or a MAC CE. For example, the DCI can indicate information for one or more groups of UEs. One UE can be associated with one group. In some embodiments, the group ID is configured by a higher layer signaling. In some embodiments, UE does not know which group the UE belongs to.

For example, the information for each group of UEs can be transmitted in a block in the DCI. The starting position or the length of a block can determined by a parameter configured by higher layer signaling. For example, the higher layer signaling can be an RRC signaling or a MAC CE.

In some embodiments, the DCI is scrambled by a specific radio network temporary identifier (RNTI). The specific RNTI is used for network energy saving information indication or for spatial or power information indication.

In some embodiments, the DCI is a specific DCI. The specific DCI is used for network energy saving information indication or for spatial or power information indication.

### Bitmap Indication

A bitmap indication can be used to indicate a port selection. For example, each bit in a bitmap can be associated with one or more first port indices. The value of each bit then indicates whether the corresponding first port index are selected, active, or valid. The bitmap can be configured by RRC signaling or indicated by the first signaling.

In some embodiments, one or more second port indices can be derived by the one or more corresponding first port indices. By deriving the second port indices based on the corresponding first port indices, fewer or smaller bitmaps may be needed, thus reducing overhead. For example, the second port index can have a same state (e.g., active, valid, etc.) as the first port index. In some embodiments, the second port index corresponds to the first port index if the difference between the two port indices is equal to M/2, where M is an integer greater than 0 and less than 129. For example, M can be a number of ports of a CSI-RS resource. In some embodiments, a second port index corresponds to a first port index if the two port indices have different polarization directions and have the same position.

In some embodiments, the bitmap indicates port indices having the same polarization direction. For example, the port of a first port index can correspond to a first polarization direction, and the port of a second port index can correspond to a second polarization direction, the first polarization direction is different from the second polarization direction. In some embodiments, the port with the first port index and the port with the second port index is in the same dual polarization antenna.

In some embodiments, each bit in the bitmap is associated with A*2 port indices, where A is a positive integer. In other words, the ports of a CSI-RS are divided into Nₚₒᵣₜₛ/(2*A) groups, where Nₚₒᵣₜₛ is the number of ports of the CSI-RS, and each bit in the bitmap is associated with a group of ports. In each group, ports in both polarization direction can be included. The port indices selected or indicated by the bitmap can include multiple pairs.

In some embodiments, the length of a bitmap is equal to Nₚₒᵣₜ/(2*A). A is an integer greater than or equal to 1. For example, A can be 1, 2, 3, or 4. In some embodiments, A is predefined value. In some embodiments, A is configured by a higher layer signaling. In some embodiments, A is indicated by a DCI or a MAC CE.

In some embodiments, the length of a bitmap is equal to N1*N2/A, where N1 and N2 are associated with the number of antenna ports a first and second direction (e.g., a horizontal and vertical direction of an antenna array). For example, 2*N1 can be the number of ports in the first direction, and 2*N2 can be the number of ports in the second direction. {N1, N2} are configured in the first CSI report configuration.

A port index can be an integer greater than or equal to 0 and less than 128. For example, in this document, port index Y can correspond to CSI-RS port Y+3000.

In some embodiments, each bit in the bitmap is associated with a port index pair, e.g., {X, X+L}, or {X, X−L}, where X is an integer greater than or equal to 0 and less than 32, and where the difference between two port indices in each pair is denoted as L. For example, the X^{th} bit in the bitmap can be associated with a port index pair {X−1, X+L−1}.

In some embodiments, each bit in the bitmap associate with a port index list {X, X+1, . . . , X+A−1, X+L, X+1+L, . . . , X+A−1+L}. X is an integer greater than or equal to 0 and less than 32. For example, the Uth bit in the bitmap can be associated with a port index list {(U−1)*A, (U−1)*A+1, . . . , (U−1)*A+A−1, (U−1)*A+L, (U−1)*A+1+L, . . . , (U−1)*A+A−1+L}, where U is an integer greater than 0. A is an integer greater than or equal to 1, e.g., 1, 2, 3, or 4.

Each bit in the bitmap indicates whether the associated port indices in the port index pair or list are selected, used, valid, indicated, or activated. For example, a value ‘1’ means the port indices in the port index pair or list are selected, and value ‘0’ means port indices in the port index pair or list are not selected. For example, if the X^{th} bit in the bitmap value is 1 this can indicates that the port indices X and X+L are selected. In another example, a value ‘1’ means the port indices in the port index pair or list are not selected, and value ‘0’ means port indices in the port index pair or list are selected.

For example, let the number of CSI-RS ports be 32, and the length of the bitmap be 16. If the bitmap is ‘1111 0000 0000 0000’, then ports {0, 1, 2, 3, 16, 17, 18, 19} are selected or active.

In another example, the Uth bit in the bitmap value is 1. This indicates the port indices {(U−1)*A, (U−1)*A+1, . . . , (U−1)*A+A−1, (U−1)*A+L, (U−1)*A+1+L, . . . , (U−1)*A+A-1+L} are active. For example, let the number of CSI-RS ports is 32, the length of a bitmap be 8, and A be 2. If the bitmap is ‘1111 0000’, then the ports {0, 1, 2, 3, 4, 5, 6, 7, 16, 17, 18, 19, 20, 21, 22, 23} are selected or active.

In some embodiments, each bit in the bitmap is associated with a group of port indices. The port index values in each group can be an arithmetic sequence with spacing I. For an antenna with 2*N1*N2 ports, I can be equal to 2*N1*N2/M. I can also be equal to Nₚₒᵣₜₛ/M. M denotes the number of groups.

In some embodiments, the bitmap indicates selection information of the port indices in a first group. In this case, port indices in the other groups can be selected based on the selection information of the port indices in the first group. For example, let the number of CSI-RS ports be 16, and the port indices be divided into 4 groups, where Group 1={0, 1, 2, 3}; Group 2={4, 5, 6, 7}, Group 3={8, 9, 10, 11}, and Group 4={12, 13, 14, 15}. If the bitmap indicates selection information of the port indices in group 1 as ‘1100’, then the implicit indication by the bitmap for 16 port indices is ‘1100 1100 1100 1100’. In other words, a bitmap indicates a same information for all groups. The number of groups can be configured by a higher layer signaling or be predefined.

### Port Index Set Indication

In some embodiments, the first signaling indicates one or more port indices, e.g., a port index set, in a first polarization direction. One or more port indices in a second polarization direction can be derived from the one or more port indices in a first polarization direction. The one or more port indices in a second polarization direction can be set to the same state as the one or more port indices in a first polarization direction. In other words, the one or more port indices in the second polarization direction are implicitly indicated by the first signaling, reducing overhead.

In some embodiments, the first signaling indicates one or more port indices, e.g., a port index set, for a first kind of ports. One or more port indices for a second kind of ports can be derived from the one or more port indices for a first kind of ports. In some embodiments, the first kind of ports are ports with index 0 to index (M/2)−1, and the second kind of ports are ports with index M/2 to index M-1. In some embodiments, the ports with first polarization direction are ports with index 0 to index (M/2)−1, and the ports with second polarization direction are ports with index (M/2) to index M-1.

In some embodiments, higher layer signaling configures a port index set list. The port index set list includes multiple port index sets. The first signaling can indicate one of the multiple port index set from the list, or indicate an index of the port index set. A port index set indicates one or more port indices in a first polarization direction, and one or more port indices in a second polarization direction can be derived from the one or more port indices in a first polarization direction.

In some embodiments, if one port index I is indicated, selected, or activated, the port index I+L or I−L is implicitly indicated, selected, or activated, where L is a positive integer.

### Number of Ports Indication

The first signaling can indicate the number of ports, Nt, used for the first CSI report configuration. Ports are then selected based on the number of ports indicated in the first signaling.

In some embodiments, the port selected is according to a predefined rule. For example, the predefined rule can specify selecting the first Nt/2 port indices along with Nt/2 port indices that are associated with the first Nt/2 port indices. For example, the port index X can be associated with port index Y when the difference between X and Y is equal to L, where L=Nₚₒᵣₜ/2, and Nₚₒᵣₜ is the number of CSI-RS ports configured in the CSI-RS resource.

In some embodiments, the predefined rules include selecting the port indices {0, 1, 2, . . . , Nt/2−1, Nₚₒᵣₜ/2, 1+Nₚₒᵣₜ/2, 2+Nₚₒᵣₜ/2, . . . , Nt/2−1+Nₚₒᵣₜ/2}.

In some embodiments, the predefined rules include selecting the port indices {Nₚₒᵣₜ−1, Nₚₒᵣₜ−2, . . . , Nₚₒᵣₜ−Nt+1, Nₚₒᵣₜ/2−1, Nₚₒᵣₜ/2−1, . . . , Nₚₒᵣₜ/2−Nt+1}.

In some embodiments, the predefined rules are the same as rules used for precoding matrix indicator (PMI) selection. In some embodiments, the predefined rule can be different based on different conditions.

In some embodiments, the predefined rules include: when N ports are selected from M ports, where M=2*N1*N2, if N is divisible by 2*N1, then select the ports in N/(2*N1) rows. If N is divisible by 2*N2 and N is not divisible by 2*N1, then select the ports in N/(2*N2) continuous columns from the (function (Y-O))^{th} column of the N2 columns. N1 and N2 are configured in the first CSI report configuration. In this case, Y=N1/2 and O=N/(4*N2). function can be round up (e.g., ceiling) or round down (e.g., floor). Otherwise, if N is not divisible by 2*N2 or N is not divisible by 2*N1, then select the ports in N/(2*X) continuous columns from the (function (Y-O))^{th} column of the N2 columns in the first X rows. In this case, Y=N1/2 and O=N/(4*X), where X=ceil (N/(2*N1)).

In some embodiments, the predefined rules include: when N ports are selected from M ports, where M=2*N1*N2, select the ports in X=N/(2*N1) rows.

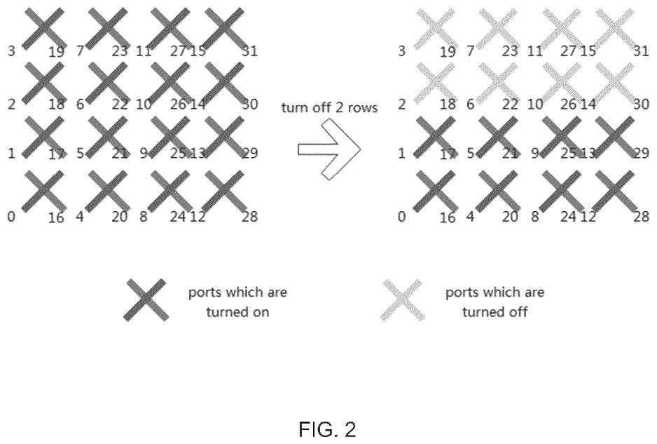

In some embodiments, the predefined rules include: when N ports are selected from M ports, where M=2*N1*N2, select the ports with port index [0,1, . . . , X−1; 0+N2, 1+N2, . . . , X−1+N2; . . . ; 0+N2*(2*N1−1), 1+N2*(2*N1−1), . . . , X−1+N2*(2*N1−1)]. In other words, select the ports with one or more port indices {Ui}, i={0, 1, . . . , X−1}, Ui=[i, i+N2, . . . , i+N2*(2*N1−1)]. An example application of this rule is shown in FIG. 2. FIG. 2 illustrates a selection of N=16 ports from M=32 ports. The numbers of ports in two directions are N1=4 and N2=4. Thus, X=16/(2*4)=2. Applying these rules, the selected port indices are [0,1; 4, 5; 8, 9; 12, 13; 16, 17; 20, 21; 24, 25; 28, 29].

In some embodiments, the predefined rules include: when N ports are selected from M ports, where M=2*N1*N2, and N is divisible by 2*N1, the ports with indices mod (floor (k/2*N1)+N2*mod (k, 2*N1), 2*N1*N2) are selected, where k=0, 1, . . . , N−1. mod (a,b) denotes the modulo operation.

In some embodiments, the predefined rules include: when N ports are selected from M ports, where M=2*N1*N2, and N is divisible by 2*N2, the ports with indices [2*Z/2, 2*Z/2+1, . . . , 2*(Z/2+Y)−1, 2*Z/2+M/2, 2*Z/2+1+M/2, . . . , 2*(Z/2+Y)−1+M/2] are selected. Y=N/(2*N2), Z=N1−Y.

In some embodiments, the predefined rules include: when N ports are selected from M ports, where M=2*N1*N2, select the ports in N/(2*N2) continuous columns from the (function (Y-O))^{th} column of the N2 columns. N1, N2 is configured in the first CSI report configuration. Y=N1/2, O=N/(4*N2), and function can be round up (e.g., ceiling) or round down (e.g., floor).

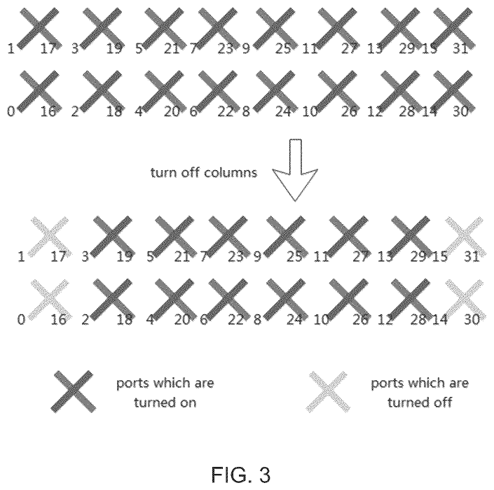

In some embodiments, the predefined rules include: when N ports are selected from M ports, where M=2*N1*N2, let Y=(M-N)/(2*N2), and X=N/(2*N2). Select the ports with port indices [Y/2*N2, Y/2*N2+1, . . . , Y/2*N2+N2-1; (Y/2+1)*N2, (Y/2+1)*N2+1, . . . , (Y/2+1)*N2+N2-1; . . . ; (Y/2+X−1)*N2, . . . , N2-1+N2*(Y/2+X−1)] and select the ports with port indices [Y/2*N2+M/2, Y/2*N2+1+M/2, . . . , Y/2*N2+N2-1+M/2; (Y/2+1)*N2+M/2, (Y/2+1)*N2+1+M/2, . . . , (Y/2+1)*N2+N2-1+M/2; . . . ; (Y/2+X−1)*N2+M/2, . . . , N2-1+N2*(Y/2+X−1)+M/2]. In other words, select the ports with one or more port indices {Vi}, i={0, 1, . . . , N2−1}, Vi=[Y/2*N2, (Y/2+1)*N2, . . . , (Y/2+X−1)*N2]. An example application of this rule is shown in FIG. 3. FIG. 3 illustrates a selection of N=24 ports from M=32 ports, where N1=8 and N2=2. Applying these rules, the selected port indices are [2, 3; 4, 5; 6, 7; 8, 9; 10, 11; 12, 13; 18, 19; 20, 21; 22, 23; 24, 25; 26, 27; 28, 29].

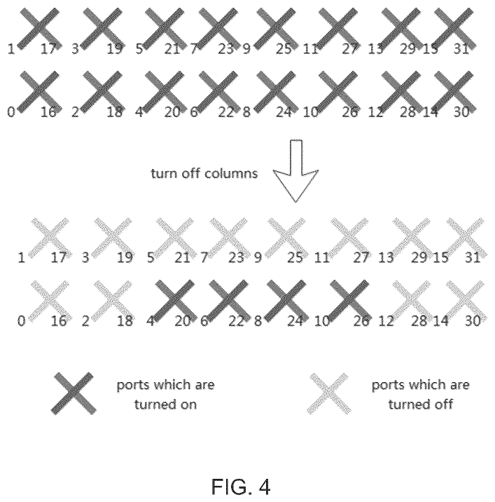

In some embodiments, the predefined rules include: when selecting N ports from M ports, where M=2*N1*N2, let Y=(2*N1−N)/2 and X=N/2. Select the ports with port indices [Y/2*N2; (Y/2+1)*N2; . . . ; (Y/2+X−1)*N2] and select the ports with port indices [Y/2*N2+M/2; (Y/2+1)*N2+M/2; . . . ; (Y/2+X−1)*N2+M/2]. An example application of this rule is shown in FIG. 4. FIG. 4 illustrates a selection of 8 ports from 32 ports, where N1=8 and N2=2. The selected port indices are [4; 6; 8; 10; 20; 22; 24; 26].

In some embodiments, the predefined rules include when selecting N ports from M ports, where M=2*N1*N2, divide the M ports into two sections with each section containing M/2 ports. Selecting N/2 ports from a first section of the M ports and select N/2 ports from a second section of the M ports based on a first rule. The first rule can comprise at least one of the following:
Select the first N/2 ports from the first section of the M ports, and select the first N/2 ports from the second section of the M ports. For example, select N=16 ports from M=32 ports, where N1=N2=4. Ports {0,1, . . . , 15} comprise the first section and ports {16, 17, . . . , 31} comprise the second section. Port {0,1, . . . , 7} and {16, 17, . . . , 23} are selected by applying these rules.
Select the last N/2 ports from the first section of the M ports, and select the last N/2 ports from the second section of the M ports.
Select (2*k−1)th ports from the first section of the M ports, and select (2*k−1)th ports from the second section of the M ports, wherein k=1, 2, . . . . N/2. For example, select N=16 ports from M=32 ports, where N1=N2=4. Ports {0,1, . . . , 15} comprise the first section, and ports {16, 17, . . . , 31} comprise the second section. Ports {0, 2, . . . , 14} and {16, 18, . . . , 30} are selected.
Selecting (2*k)^{th} ports from the first section of the M ports, and select (2*k)^{th} ports from the second section of the M ports, wherein k=1, 2, . . . . N/2.

In some embodiments, the predefined rules include: when selecting N ports from M ports, where M−2*N1*N2, divide the M ports into P sections with each section containing M/P ports. Select N/P ports from each of the P sections of the M ports. In some embodiments, P is predefined or configured by a higher layer signaling.

In some embodiments, the predefined rules include: when selecting N ports from M ports, where M−2*N1*N2, divide the M ports into four sections with each section containing M/4 ports. Selecting N/4 ports from each of the four sections of the M ports based on a first rule. The first rule can comprise at least one of the following:
Select the first N/4 ports from the each section of the M ports. For example, select N=16 ports from M=32 ports, where N1=N2=4. Ports {0,1, . . . , 7} comprise the first section, ports {8, 9, . . . , 15} comprise second section, ports {16, 17, . . . , 23} comprise the third section, and ports {24, 25, . . . , 31} comprise the fourth section. Port {0,1, 2, 3}, {8, 9, 10, 11}, {16, 17, 18, 19}, and {24, 25, 26, 27} are selected.
Select the last N/4 ports from each section of the M ports.
Select (2*k−1)^{th} ports from each section of the M ports, wherein k=1, 2, . . . , N/4.
Select (2*k)^{th} ports from each section of the M ports, wherein k=1, 2, . . . , N/4. For example, select N=16 ports from M=32 ports, where N1=N24. Ports {0,1, . . . , 7} comprise the first section, ports {8, 9, . . . , 15} comprise the second section, ports {16, 17, . . . , 23} comprise the third section, and ports {24, 25, . . . , 31} comprise the fourth section. Port {1, 3, 5, 7}, {9, 11, 13, 15}, {17, 19, 21, 23}, and {25, 27, 29, 31} are selected.
In some embodiments, the predefined rules include: when selecting N ports from M ports, where M=2*N1*N2, divide the M ports 2*Ng sections, where Ng is a positive integer, with each section containing M/(2*Ng) ports. Select N/(2*Ng) ports from each section of the M ports based on a first rule. In some embodiments, Ng is a number of antenna panels. In some embodiments, Ng is configured by higher layer signaling. The first rule can comprise at least one of the following:
Select the first N/(2*Ng) ports from each section of the M ports.
Select the last N/(2*Ng) ports from each section of the M ports;
Select (2*k−1)^{th} ports from each section of the M ports, wherein k=1, 2, . . . , N/(2*Ng).
Select (2*k)^{th} ports from each section of the M ports, wherein k=1, 2, . . . , N/(2*Ng).

In some embodiments, the predefined rules include: when selecting N ports from M ports, where M−2*Ng*N1*N2, select the first N ports from the M ports or selecting the last N ports from the M ports.

In some embodiments, the predefined rules include: when selecting N ports from M ports, where M−2*Ng1*N1_1*N2_1, N=2*Ng2*N1_2*N2_2, if Ng1>Ng2, select the first N ports from the M ports or select the last N ports from the M ports. Otherwise, divide the M ports into 2*Ng sections with each section containing M/(2*Ng) ports, and select N/(2*Ng) ports from each section of the M ports based on a first rule. For example, the first rule can include any of the “first rules” listed above.

### N1, N2

N1, N2 can also be used as information for port selection. N1, N2 respectively refer to numbers of antenna ports in a first and second dimension. N1, N2 can be used to determine numbers of antenna ports in a horizontal and vertical dimension. For example, the number of antenna ports in a horizontal dimension can be 2*N1, and the number of antenna ports in a vertical dimension is 2*N2.

In some embodiments, higher layer signaling configures a list of {N1, N2} sets. The {N1, N2} set list includes multiple {N1, N2} sets. First signaling (e.g., as previously described,) indicates one from the multiple {N1, N2} sets. The first signaling can indicate an index of the {N1, N2} set.

In some embodiments, if one {N1, N2} set is indicated, the first 2*N1*N2 port indices are selected.

In some embodiments, if one {N1,N2} set is indicated, the port indices in the first N1 columns and first N2 rows are selected.

In some embodiments, if one {N1,N2} set is indicated, the port indices in the first N1 columns and N/(2*N2) continuous columns from the (function (Y-O))^{th} column in a second antenna array. The function can be a rounding function, e.g., ceiling or floor. The second antenna array is associated with another {N1,N2} value configured in a CSI-RS resource.

In some embodiments, if one {N1,N2} set is indicated, the number of ports are determined according to 2*N1*N2, the ports which are selected according the number of ports. The methods of selecting multiple ports according to a number of ports are provided in the patent.

In some embodiments, a field in the first signaling indicates {N1, N2}. A first part of the field can be used to indicate N1, and a second part of the field can be used to indicate N2. Alternatively, the first part of the field can be used to indicate an index of N1, and the second part of the field can be used to indicate an index of N2. In some embodiments, the first part is 4 bits, the second part is 2 bits.

### Scaling Factor

In some embodiments, a scaling factor is indicated by a first signaling. In some embodiments, the scaling factor is greater than or equal to 0 and less than 10. For example, ½, ¼, ⅛, ⅓, ⅜, 1, 2, 3, 4, 8. In some embodiments, the scaling factor is used to determine a second number of ports according to a first number of ports. The first number of ports is the number of ports configured, activated, or indicated for a CSI-RS resource. The second number of ports is determined by multiplying the first number of ports by the scaling factor. After receiving a scaling factor indication, UE can select the second number of ports from the first number of ports.

In some embodiments, a field in a first signaling can be used to indicate one or more of the configured scaling factors. The bitwidth of the field is determined according to at least one of the following: the number of configured scaling factors, the maximum number of configured scaling factors, or by higher layer signaling.

In some embodiments, RRC may configure one or more antenna muting patterns, further described below. Each antenna muting pattern can be associated with one scaling factor. In some embodiments, a second signaling indicates a scaling factor from the one or more scaling factors, and the first signaling indicates an antenna muting pattern from the one or more antenna muting pattern which are associated with the scaling factor. In some embodiments, the second signaling is a MAC CE, and the first signaling is a DCI or MAC CE.

### Antenna Muting Pattern

In some embodiments, one or more antenna muting patterns are configured by a higher layer signaling. The first signaling indicates one or more antenna muting patterns from the configured one or more antenna muting patterns and/or a predefined antenna muting pattern. In some embodiments, an “antenna muting pattern” can refer to a set of ports that are not necessarily based on configurations of rows or columns.

In some embodiments, M antenna muting patterns are configured by a higher layer signaling. A first signaling indicates N antenna muting patterns from the M antenna muting patterns. A second signaling indicates Y antenna muting patterns from the N antenna muting patterns indicated by the first signaling and/or a predefined antenna muting pattern. M, N, and Y are integers greater than 0, where M≥N≥Y. In some embodiments, the first signaling is a MAC CE, and the second signaling is a DCI.

In some embodiments, the predefined antenna muting pattern indicates that all ports are selected or valid, or that all ports are not selected or invalid.

In some embodiments, a codepoint is used to indicate one antenna muting pattern from the configured one or more antenna muting patterns and/or a predefined antenna muting pattern. A specific codepoint can indicate all ports are selected. For example, an all ‘0’ codepoint can indicate all ports are selected. In another example, an all ‘1’ codepoint indicates all ports are selected. Similarly, a specific codepoint can indicates all ports are not selected. For example, the all ‘0’ codepoint can indicate all ports are not selected, or an all ‘1’ codepoint indicates all ports are not selected.

The predefined antenna muting pattern can have at least one of the following properties:
The antenna muting pattern indicates all ports are activated or valid. For example, the value of all the bits in a bitmap is 1.
The antenna muting pattern indicates all ports are de-activated or invalid. For example, the value of all the bits in a bitmap is 0.
The antenna muting pattern indicates 24 ports or 12 ports are activated or valid.

In some embodiments, the antenna muting pattern is indicated by a bitmap. In some embodiments, the length of the bitmap for a first antenna muting pattern is same as the number of bits which have value ‘1’ in a second antenna muting pattern. The first antenna muting pattern indicates a first number of ports which are activated or valid, and the second antenna muting pattern indicates a second number of ports which are activated or valid. The first number of ports is less than the second number of ports. For example, the first antenna muting pattern can indicate a subset of ports that are indicated by the second antenna muting pattern. Additional numbers of antenna muting patterns can be used to indicate further selections.

For example, a first antenna muting pattern indicates 32 ports are activated or valid is ‘1111 1111 1111 1111’. The Xth bit of a corresponding bitmap indicates port indices {X−1, X+15}. A second antenna muting pattern indicating 24 ports are activated or valid is ‘1111 1111 1111 0000’, meaning port indices {0,1, 2, 3, 4, 5, 6, 7, 8, 9, 10, 11, 16, 17, 18, 19, 20, 21, 22, 23, 2, 4, 25, 26, 27} are selected. A third antenna muting pattern indicating 16 ports are activated or valid is ‘1111 1111 0000’, meaning port indices {0,1, 2, 3, 4, 5, 6, 7, 16, 17, 18, 19, 20, 21, 22, 23} are selected. A fourth antenna muting pattern indicating 12 ports are activated or valid is ‘1111 1100’, meaning port indices {0,1, 2, 3, 4, 5, 16, 17, 18, 19, 20, 21} are selected. A fifth antenna muting pattern indicating 8 ports are activated or valid is ‘1111 00’, meaning port indices {0,1, 2, 3, 16, 17, 18, 19,} are selected. A sixth antenna muting pattern indicating 4 ports are activated or valid is ‘0011’, meaning port indices {2, 3, 18, 19} are selected.

In some embodiments, the length of the bitmap for all antenna muting patterns are the same. For example, the bits with value 0 of the bitmap for a first antenna muting pattern can be the same as a bitmap for a second antenna muting pattern. However, the bits with value 1 of the bitmap for the first antenna muting pattern can be changed to value 0 in a bitmap for the second antenna muting pattern. In another words, a value 0 is not changed, while a value 1 can change to 0. The first antenna muting pattern indicates a first number of ports which are activated or valid, the second antenna muting pattern indicates a second number of ports which are activated or valid. The first number of ports is less than the second number of ports. For example, the first antenna muting pattern indicates a subset of ports indicated by the second antenna muting pattern.

For example, a first antenna muting pattern indicating 16 ports are activated or valid is ‘0000 1111 1111 0000’, meaning port indices {4, 5, 6, 7, 8, 9, 10, 11, 20, 21, 22, 23, 24, 25, 26, 27} are selected. A second antenna muting pattern indicating 12 ports are activated or valid is ‘0000 1111 1100 0000”, means port indices {4, 5, 6, 7, 8, 9, 20, 21, 22, 23, 24, 25} are selected. As shown, when comparing the first and second antenna muting patterns, the 11th and 12th bits have changed from “1” to “0,” but the “0” bits of the first antenna muting pattern are unchanged.

In some embodiments, the first half bits in the bitmap of an antenna muting pattern is the same as the second half bits in the bitmap. For example, for a bitmap of length 8, the first four bits can be the same value as the last four bits. In general, the bitmap can be divided into M subsets, where the bit values in the M subsets are the same.

In some embodiments, the bitmap used to indicate an antenna muting pattern can be implement the same designs as described elsewhere in this document, such as regarding port selection. Similarly, the bitmap design used for the antenna muting parameter can also be used for port selection.

In some embodiments, an antenna muting pattern is a bitmap, a port index set, or a set {N1, N2}.

In some embodiments, a first signaling indicates a number of ports and an antenna muting pattern corresponding to the number of ports. For example, RRC signaling can be used to configure M numbers of ports, where each value of M is associated with one or more antenna muting patterns. The first signaling indicates two parts, where a first part selects a number of ports from the M number of ports, and the second part selects an antenna muting pattern from the several antenna muting pattern which are associated with the selected number of ports.

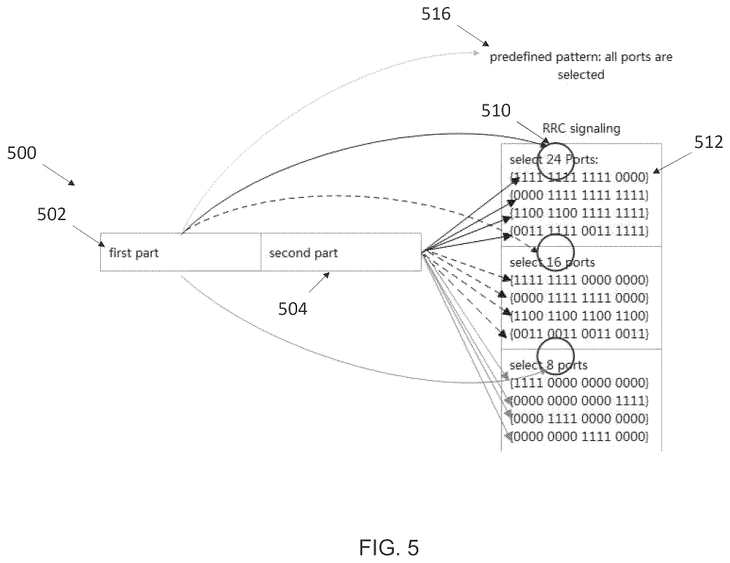

An example is shown in FIG. 5. The first part 502 of first signaling 500 selects a number of ports 510. A second part 504 of the first signaling 500 selects an antenna muting pattern 512 corresponding to the selected number of ports 510. In addition, the first signaling 500 can select a predefine antenna muting pattern 516, such as one that indicates all ports are selected.

### Multiple CSI Reporting

If the network indicates that the UE reports multiple CSI reports according to one CSI report configuration, the following techniques may be used.

In some embodiments, a first signaling indicates at least one of the following: one or more bitmap indications, one or more port index sets, one or more {N1,N2}, one or more antenna muting patterns, an index, a maximum number of ports, a minimum number of ports, a number of CSI reports, a scaling factor, or a number of antenna muting patterns.

A codepoint or a second bitmap in a field of the first signaling can be used to indicate one or more bitmap indications, one or more port index sets, one or more {N1,N2}, one or more antenna muting patterns, an index, a maximum number of ports, a minimum number of ports, a number of CSI reports, a scaling factor, or a number of antenna muting patterns.

For example, a codepoint in a field of the first signaling can indicate a number of CSI reports. The bitwidth (Biw) of a field is determined by the maximum number of CSI reports (Uₘ). For example Biw=function (log₂ (Uₘ)), function is one of round up, round down, round. Each codepoint of the field indicates a number of CSI report.

In some embodiments, a maximum number of CSI reports reported in one reporting can be configured in the first CSI report configuration.

If a number of CSI reports, Nr, is indicated, then Nr antenna muting patterns, bitmaps, or port indices list are selected using predefined rules. For example, the predefined rule can specify that the Nr antenna muting patterns, bitmaps, or port indices list with the lowest or highest indices are selected.

In some embodiments, a codepoint is used to indicate a number of selected bitmap indications, a number of selected port index set, a number of selected sets {N1,N2}, or a number of selected antenna muting patterns.

The bitwidth (Biw) of a field used in the first signaling can be determined by the number of antenna muting patterns, bitmaps, {N1,N2} sets, or port indices set (Uₘ) configured in higher layer signaling. For example, Biw can be a function of log₂ (Uₘ). In some embodiments, the function is one of: round up (e.g., ceiling), round down (e.g., floor), or round.

The bitwidth (Biw) of a field used in the first signaling can be determined by a maximum number of antenna muting patterns, bitmaps, {N1,N2} sets, or port indices set (Uₘ) configured in higher layer signaling for a bandwidth part (BWP), an UE, or a serving cell. For example, Biw can be a function of log₂ (Uₘ). In some embodiments, the function is one of: round up (e.g., ceiling), round down (e.g., floor), or round.

If a number (Nr) is indicated, Nr antenna muting pattern can be selected using predefined rules.

In some embodiments, multiple antenna muting patterns, multiple bitmaps, multiple {N1,N2} sets, or multiple port indices set are configured in association with a first CSI report configuration or a CSI-RS resource. For example, a second bitmap can be used to indicate one or more antenna muting patterns, one or more bitmaps, one or more sets of port indices, or one or more sets {N1,N2}. Each bit in the field can indicates an antenna muting pattern, bitmap, set of port indices, or a set {N1,N2}. For example, each bit can indicates whether or not the antenna muting pattern, bitmap, set of port indices, or set {N1,N2} is selected.

In some embodiments, a bitwidth (Biw) of a field used to indicate a number of CSI reports in the first signaling is determined by the number of antenna muting pattern, {N1,N2}, bitmap, or port indices set (Uₘ) configured in higher layer signaling. For example, Biw=Uₘ.

In some embodiments, a bitwidth (Biw) of a field used to indicate a number of CSI reports in the first signaling is determined by the maximum number of antenna muting pattern, {N1,N2}, bitmap, or port indices set (Uₘ) can be configured in one BWP, one serving cell, or one CSI report configuration. For example Biw=Uₘ.

If the number of antenna muting patterns, {N1,N2}, bitmaps, or port indices set (Ux) configured in one BWP, one serving cell, or one CSI report configuration is smaller than the maximum number (Uₘ), then the first Ux bits are used.

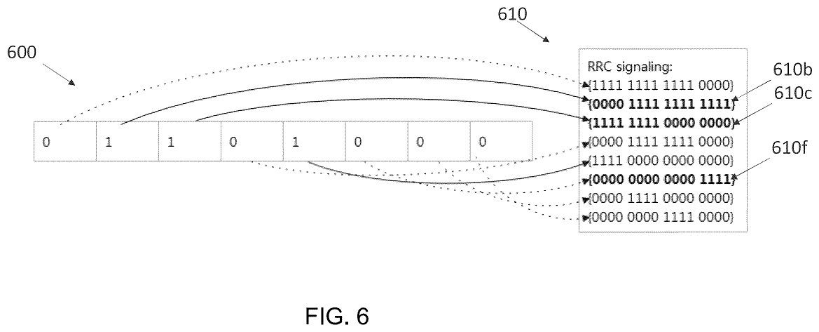

An example of how multiple bitmaps are indicated is shown in FIG. 6. 8 bitmaps 610 are configured by RRC signaling. A bitmap 600 of length 8 is used to indicate one or more of the bitmaps 610. The bitmaps 610b, 610c, and 610f are selected as shown in FIG. 6.

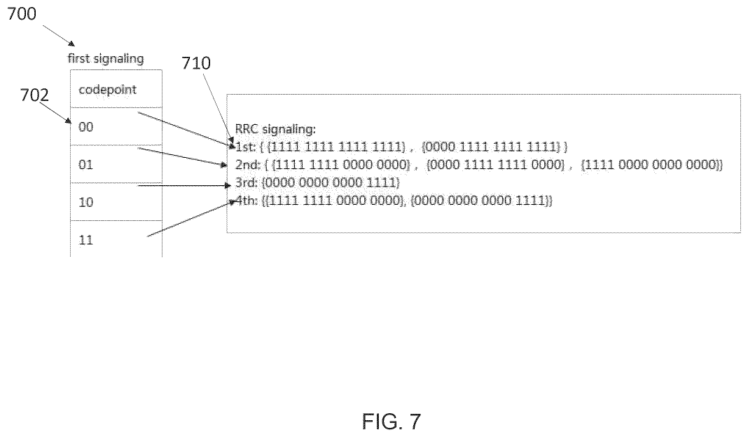

In some embodiments, higher layer signaling configures a pattern set list. The pattern set list includes one or more pattern sets. A pattern set includes one or more antenna muting patterns, one or more bitmap indication, one or more port index list, or one or more sets {N1,N2}. The first signaling can indicate an index of the pattern set list that corresponds to a pattern set in the pattern set list. For example, as shown in FIG. 7, different codepoints 702 in first signaling 700 indicates an index 710 of the pattern set list.

In some embodiments, the pattern set list includes M pattern sets. A first signaling can indicates N indices of the pattern set list. A second signaling then indicates one index from the N indices that corresponds to a pattern set in the pattern set list.

In some embodiments, the first signaling indicates a maximum number of ports. A CSI report for a number of ports which is not greater than maximum number of ports is reported. The first signaling can similarly indicate a minimum number of ports. In this case, a CSI report for a number of ports which not less than the minimum number of ports is reported.

In some embodiments, first signaling indicates a first antenna muting pattern. One or more second antenna muting patterns can be derived from the first antenna muting pattern. For example, the second antenna muting patterns can includes P1 antenna muting pattern with a smaller number of ports than the first antenna muting pattern (if configured) and P2 antenna muting patterns with a larger number of ports than the first antenna muting pattern (if configured). P1 and P2 are integers greater than or equal to 0. In some embodiments, P1=P2.

In some embodiments, RRC configures one or more antenna states. The antenna states indicate a portion of the ports or antennas that are on or off. For example, the antenna states can indicate a fraction of the total ports or antennas, such as ½, ¾, ¼, ⅜, ⅛, ⅓, ⅔, etc. For the antenna states configured by RRC signaling, one or more antenna muting patterns are configured. The antenna muting pattern should satisfied the configured antenna states.

In some embodiments, a field in a first signaling can be used to indicate one or more of the configured antenna muting patterns. The bitwidth of the field is determined according to at least one of the following: the number of configured antenna muting patterns, the maximum number of configured antenna muting patterns, or higher layer signaling.

In some embodiments, a second signaling indicates an antenna state from the one or more antenna states, and a first signaling indicates an antenna muting pattern from the one or more antenna muting patters which are associated with the antenna state. In some embodiments, the second signaling is a MAC CE, the first signaling is a DCI or MAC CE.

### Multiple CSI-RS Resources

In some embodiments, a UE is configured with a first CSI report configuration, and the first CSI report configuration is associated with a CSI-RS resource with multiple resource parameters. The UE reports one or multiple CSI reports based on the first CSI report configuration and/or a first signaling. The first signaling can includes at least one of the following: a number of port indications, {N1, N2}, a power offset, or a resource parameter indication. In some embodiments, a bitmap or a codepoint in a field of the first signaling is used to indicate at least one of the following: one or more number of port indications, one or more sets {N1, N2}, one or more power offsets, or one or more resource parameter indications.

In some embodiments, a valid number of ports of CSI-RS is at least one of: 1, 2, 4, 8, 12, 16, 24, or 32. Let the number of valid number of port be denoted as Uv. In some embodiments, Uv is configured by higher layer signaling. In some embodiments, Uv is a predefined value. In some embodiments, a valid number of ports of CSI-RS is predefined. In some embodiments, a valid number of ports is the number of ports configured in association with the first CSI report configuration.

In some embodiments, a field in the first signaling indicates a number of ports. The bitwidth of the field can be a function of log₂ (Uv). For example, the function can one of round up (e.g., ceiling), round down (e.g., floor), or round. Each codepoint of the indication of the number of ports corresponds to a valid number of ports. A CSI-RS resource associated with the indicated number of ports are selected.

The first signaling can include a resource parameter indication. The number of valid resource parameters can be denoted as Uv. In some embodiments, Uv is configured by higher layer signaling. In some embodiments, Uv is a predefined value. In some embodiments, a valid resource parameter is predefined. In some embodiments, Uv is the number of resource parameters associated with the first CSI report configuration.

In some embodiments, a field in first signaling indicates a resource parameter. The bitwidth of the field is function of log₂ (Uv). For example, the function can be one of round up (e.g., ceiling), round down (e.g., floor), round. The resource parameter indication indicates a resource parameter, and the CSI-RS resource with the indicated resource parameter is selected or used. In some embodiments, the bitwidth of the resource parameter indication is configured by a higher layer signaling. In some embodiments, the mapping between a codepoint and resource parameter is predefined.

In some embodiments, Uv is a maximum number of valid resource parameters configured in one first CSI report configuration. In some embodiments, Uv is the maximum number of valid resource parameters configured in a serving cell, a BWP, or configured for a UE.

In some embodiments, RRC configures one or more antenna states. The antenna states indicate a portion of the ports or antennas that are on or off. For example, the antenna states can indicate a fraction of the total ports or antennas, such as ½, ¾, ¼, ⅜, ⅛, ⅓, ⅔, etc. For the antenna states configured by RRC signaling, one or more resource parameters (e.g., CSI-RS resource, CSI-RS resource set, number of ports) are configured. The resource parameters satisfy the configured antenna states.

In some embodiments, a field in a first signaling can be used to indicate one or more of the configured resource parameters. The bitwidth of the field is determined according to at least one of the following: the number of configured resource parameters, the maximum number of configured resource parameters, or higher layer signaling.

In some embodiments, a second signaling indicates an antenna state from the one or more antenna states, and a first signaling indicates a resource parameter from the one or more resource parameters which are associated with the antenna state. In some embodiments, the second signaling is a MAC CE, and the first signaling is a DCI or MAC CE.

In some embodiments, the network indicates information for multiple CSI reports in one CSI report configuration. For example, the first signaling can indicates whether one or more resource parameters are selected or valid according to a bitmap, e.g., each bit in the bitmap corresponds to one resource parameter. A value of the bit indicates whether the resource parameter is selected or valid. For example, value ‘0’ means not selected or invalid, and value ‘1’ means selected or valid. The length of the bitmap can be determined by at least one of the following:
1. Number of different resource parameters configured for a UE.
2. Number of different resource parameters configured in a BWP or a serving cell.
3. Maximum number of resource parameters can be configured for a UE or in a BWP or in a serving cell.
4. Maximum number of resource parameters can be configured.
5. Configured by a higher layer signaling.
6. Predefined value.
7. Reported by a UE capability. For example, the length of the bitmap can be set to the maximum number of resource parameters that can be configured.

The resource parameters indication can be at least one of the following: resourceMapping indication, number of port indication, CRI indication, resource ID indication, group indication, power offset indication, resource set ID indication, resource setting ID indication. In some embodiments, a resource parameter corresponds to a bitmap for power index (as described elsewhere in this document,) or a port index list.

### UE Behavior

In some embodiments, a UE is configured with a first CSI report configuration. The first CSI report configuration is associated with one or more CSI-RS resources with multiple patterns. The pattern corresponds to a resource parameter, antenna muting pattern, or bitmap.

If UE does not receive a first signaling that indicates information to select one or more patterns, a predefined patterns is used. The predefined pattern is at least one of the following:
A pattern with a lowest index.
A pattern with highest index.
A pattern with a largest number of ports or largest power offset.
A pattern with a smallest number of ports or smallest power offset.
A pattern with a predefined number of ports or predefined power offset.
All the patterns configured associated with the first CSI report configuration.

In some embodiments, the UE measures and reports a CSI report for each pattern in turn. For example, the UE can measure and report a CSI report for first pattern in a first CSI report cycle, and then measure and report a CSI report for a second pattern in a second CSI report cycle. In some embodiments, UE reports the pattern index which the CSI report is associated with.

If UE does not receive data scheduling for a period of time (e.g., configured by a timer, or a timer expires), a predefined pattern can be selected or valid. The predefined pattern is at least one of the following:
A pattern with a lowest index.
A pattern with highest index.
A pattern with a largest number of ports or largest power offset.
A pattern with a smallest number of ports or smallest power offset.
A pattern with a predefined number of ports or predefined power offset.
All the patterns configured associated with the first CSI report configuration.

If a UE receives a first signaling with an invalid indication, the UE can perform least one of the following:
A predefined pattern(s) is selected or valid. UE uses the predefined pattern to report CSI.
UE ignores the indication.

In some embodiments, an invalid indication refers to an indication that indicates a bitmap, pattern, number of ports, port index, or power offset that the UE does not configure. The invalid indication can also indicate a number of CSI reports reported in one reporting that exceeds UE capability, or a maximum number of CSI reported in one reporting, configured by higher layer signaling.

As previously discussed, multiple CSI reports can be reported based on a CSI report configuration. Multiple CSI reports are reported in one reporting can also refer to multiple CSIs being reported in one CSI report.

The multiple CSI reports in one reporting includes at least a first CSI report. The first CSI report comprises at least rank indicator (RI), precoding matrix indicator (PMI), or channel quality indicator (CQI). In some embodiments, first CSI report is associated with a maximum number of ports, a largest power offset, a smallest power offset, a reference CSI-RS resource, or all ports of the CSI-RS resource. The multiple CSI reports in one reporting can also include a second CSI report. A second CSI report can be associated with a subset of the ports of the CSI-RS resource, or a pattern not associated with the maximum number of ports, the largest power offset, or the smallest power offset. The reference CSI-RS resource includes at least one of the following: a CSI-RS resource with lowest index in a CSI-RS resource set; a CSI-RS resource set with lowest index; a CSI-RS resource setting with lowest index; a predefined CSI-RS resource set; or a CSI-RS resource configured by higher layer signaling.

The multiple CSI reports in one reporting also includes one or more second CSI report. The second CSI report can comprise at least one of: RI, differential RI, differential CQI, or column selection for a precoding matrix. The differential RI is a differential value with reference to the RI reported in the first CSI report. The differential CQI is a differential value with reference to the CQI reported in the first CSI report.

The column selection information for precoding matrix indicates which columns in a first precoding matrix (or codebook) are used for a second precoding matrix. The first precoding matrix is determined according to a first PMI. The first PMI is the PMI reported in a first CSI report. The second precoding matrix is a subset of the first precoding matrix. The second precoding matrix is associated with the CSI-RS resource or a pattern not associated with a maximum number of ports, largest power offset, or smallest power offset.

The column selection information for precoding matrix can be a bitmap, where each bitmap corresponds to one column. For example ‘0’ means the column is not used, and ‘1’ means the column is used.

In some embodiments, a second CSI report does not comprise at least one of the following: PMI, CQI.

In some embodiments, a second CSI report comprises at least one of the following: a differential PMI or a differential CQI. The differential PMI can be a differential value with reference to the PMI reported in the first CSI report. The differential CQI can be a differential value with reference to the CQI reported in the first CSI report. In some embodiments, the differential PMI refers to the PMI reported in the first CSI report. For example, the differential PMI can include parameters associated with the PMI parameters (e.g., i1-1, i1-2, i2) reported in the first CSI report.

In some embodiments, the multiple CSI reports reported in one reporting includes at least one of the following: a joint RI, one RI, M RIs, one PMI, one CQI, M CQIs, (M−1) differential RI, (M−1) differential PMI, (M−1) differential CQI, or a column selection information. M denotes the number of CSI reports reported in one reporting, or the number of activated or selected pattern.

For example, multiple CSI reports reported in one reporting can includes a joint RI, one PMI, and one CQI. In another example, multiple CSI reports reported in one reporting includes M RI, one PMI, and one CQI. In another example, multiple CSI reports reported in one reporting includes M RI, one PMI, one CQI, and (M−1) differential CQI. In another example, multiple CSI reports reported in one reporting includes M RI, one PMI, one CQI, (M-1) differential PMI, and (M−1) differential CQI. In another example, multiple CSI reports reported in one reporting includes joint RI, one PMI, one CQI, and (M−1) differential CQI. In another example, multiple CSI reports reported in one reporting includes joint RI, one PMI, one CQI, (M−1) differential PMI, and (M−1) differential CQI. In another example, multiple CSI reports reported in one reporting includes one RI, one PMI, one CQI, (M−1) differential CQI, and (M−1) differential RIs.

In some embodiments, when one or more CSI reports are associate with a first CSI report configuration, multiple PUCCH resources are configured in a first CSI report configuration.

For example, a PUCCH resource can be associated with one or more pattern, or one or more numbers of CSI reports. For example, a first PUCCH resource can be used if one or two CSI reports are included in one reporting, and a second PUCCH resource can be used if more than two CSI reports are included in one reporting. In some embodiments, the mapping between a PUCCH resource and a number of CSI reports is predefined or configured by a higher layer signaling.

The first signaling can explicitly or implicitly indicate the number of CSI reports in one reporting. Different number of CSI reports in one reporting generally needs different size PUCCH resources. If only one PUCCH resource is configured, then the one PUCCH resource may be unable to accommodate different numbers of CSI reports in one reporting. For instance, a larger PUCCH resource may waste resources when a small number of CSI reports are reported, while a small PUCCH resource may not be insufficient when a large number of CSI reports are reported. Thus, the mapping provided above addresses these issues.

In some embodiments, a PUCCH resource is selected by the UE according to a number of bits (Mc) of the multiple CSI reports and a maximum number of bits carried by a PUCCH resource. The maximum number of bits carried by a PUCCH resource is related to the resource elements (REs) of the PUCCH resource, modulation order, or configured code rate.

For example, let P PUCCH resources be configured. Mj (j=1, . . . , P) is the jth maximum number of bit of the jth PUCCH resource. The following pseudocode may be used to determine which PUCCH resource is used.

```
For j=1:P
    If Mc<=Mj
        Using the jth PUCCH resource;
      End
  End
  If Mc>MP
      Using the Pth PUCCH resource;
  end
```

### Codebook, CSI Interference Measurement (CSI-IM)

In some embodiments, for a first CSI report configuration associated with one CSI-RS resource, and when one or more CSI reports are reported in one reporting of the first CSI report configuration, the first CSI report configuration is configured with multiple codebook subset restrictions. Each codebook subset restriction can be associated with a number of ports or a power offset. For example, if the first signaling indicates an information about a port selection or power offset selection, the corresponding codebook subset restriction is also selected or used.

In some embodiments, for a first CSI report configuration associated with a CSI-RS resource with multiple patterns, and one or more CSI reports are reported in one reporting of the first CSI report configuration, the first CSI report configuration is configured with multiple codebook subset restriction. Each codebook subset restriction can be associated with a number of ports or a power offset. For example, if the first signaling indicates an information about a port selection or power offset selection, the corresponding codebook subset restriction is also selected or used.

In some embodiments, for a first CSI report configuration associated with a CSI-RS resource with multiple patterns, and when one or more CSI reports are reported in one reporting of the first CSI report configuration, the number of CSI-IM resources configured in a resource set is the same as the number of CSI-RS resources for channel measurement for a predefined pattern or for a maximum number of ports associated with the CSI-RS resource.

In some embodiments, the UE reports multiple CSI reports in one reporting according to a CSI report configuration, and the CSI report configuration is associated with multiple CSI-RS resources with multiple numbers of ports. A minimum number of ports associated with the CSI report configuration can be set as no smaller than U. U is an integer value greater than or equal to 2. For example, U is 2, 4, or 8.

### Application Delay

In some embodiments, the information indicated in the first signaling is valid after an application delay. The information is “valid” when the UE can use indicated ports, power offset, resource parameters to calculate CSI. In addition, the information is “valid” when indicated ports or CSI-RS resources are active. Finally, the information is considered “valid” when the UE can report CSI according to the CSI report configuration and the information indicated in the first signaling.

The UE can provide a valid CSI report for a report if the first uplink symbol carrying the CSI report(s) starts no earlier than symbol Yref, including the effect of the timing advance. Yref is at least one of the following:
The next uplink symbol with its cyclic prefix (CP) starting T_{proc,CSI}=(Z)(2048+144)·κ2^{-μ}·T_{c}+T_{switch} after the end of the last symbol of the first signaling;
The next uplink symbol with its CP starting application delay after the end of the last symbol of the first signaling;
The next uplink symbol with starting application delay after the end of the last symbol of the first signaling;
The next uplink symbol with its CP starting T′_{proc,CSI}=(Z′)(2048+144)·κ2^{-μ}·T_{c} after the end of the last symbol in time of the latest of: valid/or selected CSI-RS resource for channel measurements, valid/or selected CSI-IM used for interference measurements, or valid or selected NZP CSI-RS for interference measurement; or.
The next uplink symbol starting a second application delay after the end of the last symbol in time of the latest of: valid or selected CSI-RS resource for channel measurements, valid/or selected CSI-IM used for interference measurements, or valid or selected NZP CSI-RS for interference measurement.

If an uplink switching gap is triggered, T_{switch} is equal to the switching gap duration, otherwise T_{switch}=0.

Z, Z′, are values about CSI processing time. κ and Tc are predefined values.

The UE does not need to provide a CSI report for a report if the first uplink symbol to carry the CSI report(s) starts earlier than symbol Yref, including the effect of the timing advance.

The application delay or second application delay is determined according to at least one of the following: Z, Z′, a predefined value, T_{switch}, a higher layer signaling, a UE capability, K0, K2, or an offset. K0 refers to a slot offset between DCI and its scheduled physical downlink shared channel (PDSCH). K2 is a slot offset between DCI and its scheduled physical uplink shared channel (PUSCH) or a slot offset between DCI and a corresponding CSI report. An offset is a time offset for semi-persistent CSI report, a time offset for aperiodic CSI report, or an offset for a periodic CSI report.

Application delay or second application delay can be determined according to a predefined value. The predefined value can be different for different subcarrier spacing (SCS) or different numbers of reports.

Application delay or second application delay can be configured by higher layer signaling. In some embodiments, application delay or second application delay is determined according to UE capability. The UE may report a value from multiple candidate capability values.

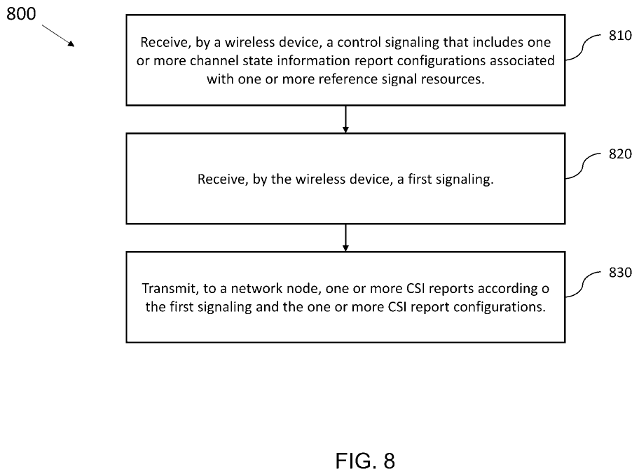

FIG. 8 is a flow diagram illustrating an example process 800 for wireless communication, in accordance with embodiments of the present disclosure. For example, the process 300 can be performed by a wireless device (e.g., wireless device 111-113 of FIG. 1).

At step 810, a wireless device receives a control signaling that includes one or more channel state information (CSI) report configurations associated with one or more reference signal (RS) resources.

At step 820, the wireless device receives a first signaling. In some embodiments, the first signaling indicates at least one of the following information: a bitmap; {N1, N2}, wherein N1 is associated with a number of ports in a first dimension and N2 is associated with a number of ports in a second dimension; a port index set; a number of CSI reports; a number of antenna muting patterns; a number of RS resource associated with a CSI report configuration; a number of PUCCH resources associated with a CSI report configuration; a power offset; a scaling factor; a codebook configuration; or a resource parameter.

In some embodiments, the first signaling indicates a bitmap that indicates one or more ports associated with the one or more CSI reports. For example, each bit in the bitmap can indicate a first state of a first port index, and a second state of a second port index can be the same as the first state of the first port index. In another example, each bit in the bitmap indicates a pair of port indices. In some embodiments, the ports in the pair have different polarization directions.

In some embodiments, the first signaling indicates a set {N1, N2}, where N1 is associated with a number of ports in a first dimension and N2 is associated with a number of ports in a second dimension, and where port indices associated with the one or more CSI reports are selected based on the set {N1, N2}.

In some embodiments, the wireless device receives, via higher layer signaling, one or more muting pattern configurations, where the one or more muting pattern configurations comprise at least one of: a bitmap, {N1,N2}, wherein N1 is associated with a number of ports in a first dimension and N2 is associated with a number of ports in a second dimension, a port index set, a number of value, a power offset, a scaling factor, a resource parameter.

In some embodiments, a first CSI report configuration of the one or more CSI report configurations is associated with multiple RS resources. The first signaling can include a field indicating a port number or a resource parameter associated with one of the multiple RS resources. In some embodiments, a length of the field is based on log₂ (Uᵥ), Uᵥ being a total number of valid ports or valid resource parameters.

At step 830, one or more CSI reports are transmitted to a network node (e.g., BS 120) according to the first signaling and the one or more CSI report configurations.

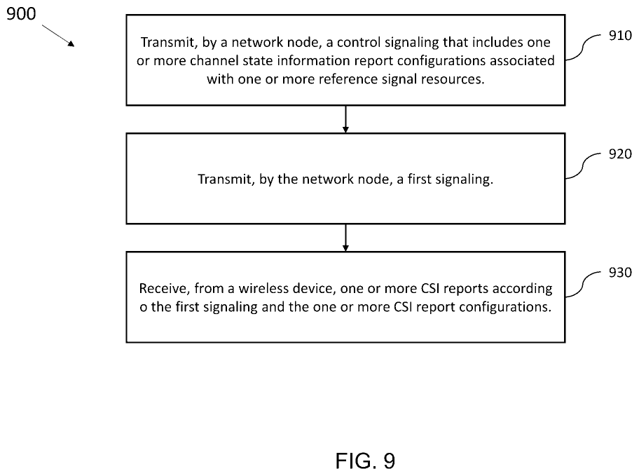

FIG. 9 is a flow diagram illustrating an example process 900 for wireless communication, in accordance with embodiments of the present disclosure. For example, the process 900 can be performed by a network node (e.g., BS 120 of FIG. 1).

At step 910, a network node transmits a control signaling that includes one or more channel state information (CSI) report configurations associated with one or more reference signal (RS) resources.

At step 820, the network node transmits a first signaling. In some embodiments, the first signaling indicates at least one of the following information: a bitmap; {N1, N2}, wherein N1 is associated with a number of ports in a first dimension and N2 is associated with a number of ports in a second dimension; a port index set; a number of CSI reports; a number of antenna muting patterns; a number of RS resource associated with a CSI report configuration; a number of PUCCH resources associated with a CSI report configuration; a power offset; a scaling factor; a codebook configuration; or a resource parameter.

In some embodiments, the first signaling indicates a bitmap that indicates one or more ports associated with the one or more CSI reports. For example, each bit in the bitmap can indicate a first state of a first port index, and a second state of a second port index can be the same as the first state of the first port index. In another example, each bit in the bitmap indicates a pair of port indices. In some embodiments, the ports in the pair have different polarization directions.

In some embodiments, the first signaling indicates a set {N1, N2}, where N1 is associated with a number of ports in a first dimension and N2 is associated with a number of ports in a second dimension, and where port indices associated with the one or more CSI reports are selected based on the set {N1, N2}.

In some embodiments, the wireless device receives, via higher layer signaling, one or more muting pattern configurations, where the one or more muting pattern configurations comprise at least one of: a bitmap, {N1,N2}, wherein N1 is associated with a number of ports in a first dimension and N2 is associated with a number of ports in a second dimension, a port index set, a number of value, a power offset, a scaling factor, a resource parameter.

In some embodiments, a first CSI report configuration of the one or more CSI report configurations is associated with multiple RS resources. The first signaling can include a field indicating a port number or a resource parameter associated with one of the multiple RS resources. In some embodiments, a length of the field is based on log₂ (Uᵥ), Uᵥ being a total number of valid ports or valid resource parameters.

At step 930, one or more CSI reports are transmitted from the network node to a wireless device according to the first signaling and the one or more CSI report configurations.

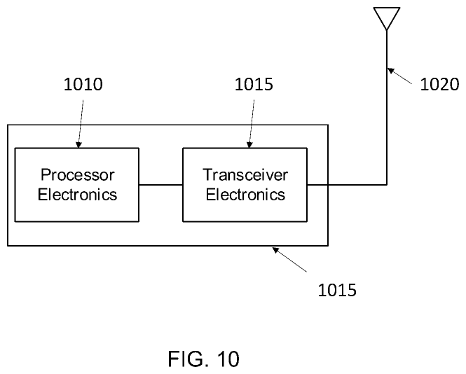

FIG. 10 is a block diagram representation of a portion of an apparatus based on some embodiments of the disclosed technology. An apparatus 1005 such as a network device or a base station or a wireless device (or UE), can include processor electronics 1010 such as a microprocessor that implements one or more of the techniques presented in this document. The apparatus 1005 can include transceiver electronics 1015 to send and/or receive wireless signals over one or more communication interfaces such as antenna(s) 1020. The apparatus 1005 can include other communication interfaces for transmitting and receiving data. Apparatus 1005 can include one or more memories (not explicitly shown) configured to store information such as data and/or instructions. In some implementations, the processor electronics 1010 can include at least a portion of the transceiver electronics 1015. In some embodiments, at least some of the disclosed techniques, modules or functions are implemented using the apparatus 1005.

It will be appreciated that the present document discloses techniques that can be embodied into wireless communication systems to provide bandwidth part specific configurations in order to reduce signaling overhead in a primary cell while supporting fast activation of the secondary cell(s).

### Solution Clauses

Some embodiments may preferably incorporate the following solutions as described herein.

For example, the clauses listed below may be used by wireless device implementations (e.g., UE 111-113 of FIG. 1) for reporting channel state information as described herein.

Clause 1. A method of wireless communication comprising: receiving, by a wireless device, a control signaling that includes one or more channel state information (CSI) report configurations associated with one or more reference signal (RS) resources; receiving, by the wireless device, a first signaling; and transmitting, to a network node, one or more CSI reports according to the first signaling and the one or more CSI report configurations.

Clause 2. The method of clause 1, wherein the first signaling indicates at least one of the following information: a bitmap; {N1, N2}, wherein N1 is associated with a number of ports in a first dimension and N2 is associated with a number of ports in a second dimension; a port index set; a number of CSI reports; a number of antenna muting patterns; a number of RS resource associated with a CSI report configuration; a number of PUCCH resources associated with a CSI report configuration; a power offset; a scaling factor; a codebook configuration; or a resource parameter.

Clause 3. The method of any of the preceding clauses, wherein the resource parameter includes at least one of: a number of ports, an indication of a port index, a power offset, a resource set identifier, a resource setting identifier, a resource identifier a transmission configuration indicator (TCI), a code division multiplexing (CDM) type, a resource mapping, a CDM group index, a frequency domain resource, a time domain resource, or a group index.

Clause 4. The method of any of the preceding clauses, wherein the information is indicated by a second bitmap, a codepoint, or an index.

Clause 5. The method of clause 4, wherein the information is indicated by the second bitmap, wherein each bit of the second bitmap is associated with a respective antenna muting pattern, set of port indices, or resource parameter, and wherein a value of each bit indicates whether the respective antenna muting pattern, the set of port indices, or the resource parameter is selected.

Clause 6. The method of any of the preceding clauses, wherein the information indicated in the first signaling is applied following a delay, wherein applying the information includes at least one of: calculating a CSI based on indicated ports, the power offset, or the resource parameter; activating the indicated ports or the one or more RS resources; or performing the one or more CSI reports according to the one or more CSI report configurations and the information.

Clause 7. The method of clause 6, wherein the delay is determined based on at least one of the following: Z, Z′, a predefined value, T_{switch}, a higher layer signaling, UE capability, K0, K2, or an offset.

Clause 8. The method of clause of any of the preceding clauses, wherein the one or more RS resources comprises at least one of: a set of resources or a resource setting.

Clause 9. The method of clause of any of the preceding clauses, wherein the first signaling indicates a bitmap that indicates one or more ports associated with the one or more CSI reports.

Clause 10. The method of clause 9, wherein each bit in the bitmap indicates a first state of a first port index, and wherein a second state of a second port index is the same as the first state of the first port index.

Clause 11. The method of clause 9 or 10, wherein each bit in the bitmap indicates a pair of port indices.

Clause 12. The method of clause 11, wherein the ports in the pair have different polarization directions.

Clause 13. The method of clause 11 or 12, wherein a difference between the port indices in the pair is equal to M/2, wherein Mis a number of ports associated with the one or more RS resources.

Clause 14. The method of clause any of clauses 9-13, wherein each bit in the bitmap is associated with A*2 port indices, A being a positive integer.

Clause 15. The method of clause any of clauses 9-14, wherein a bit in the bitmap is associated with a group of port indices, wherein port indices of the group of port indices comprise an arithmetic sequence.

Clause 16. The method of any of clauses 9-15, wherein a first half of the bitmap has the same values as a second half of the bitmap.

Clause 17. The method of any of the preceding clauses, wherein the first signaling indicates N ports, N being a positive integer, and wherein the N ports are selected based on the value of N and a predefined rule.

Clause 18. The method of any of the preceding clauses, wherein the first signaling indicates a set {N1, N2}, wherein N1 is associated with a number of ports in a first dimension and N2 is associated with a number of ports in a second dimension, and wherein port indices associated with the one or more CSI reports are selected based on the set {N1, N2}.

Clause 19. The method of any of the preceding clauses, further comprising: receiving, via higher layer signaling, one or more muting pattern configurations, wherein the one or more muting pattern configurations comprise at least one of: a bitmap, {N1,N2}, wherein N1 is associated with a number of ports in a first dimension and N2 is associated with a number of ports in a second dimension, a port index set, a number of value, a power offset, a scaling factor, a resource parameter.

Clause 20. The method of any of the preceding clauses, further comprising: receiving one or more muting pattern configurations, wherein the one or more muting pattern configurations includes (1) a first muting pattern configuration indicating a first number of valid or activated ports, and (2) a second muting pattern configuration indicating a second number of valid or activated ports, wherein the second number is less than the first number, and wherein ports not indicated as valid or activated by the first muting pattern configuration are not indicated as valid or activated by the second muting pattern configuration.

Clause 21. The method of any of the preceding clauses, wherein a first CSI report configuration of the one or more CSI report configurations is associated with one or more RS resources, wherein the first signaling includes a field indicating a port number, an antenna muting pattern, or a resource parameter associated with one of the one or more RS resources, and wherein a length of the field is based on log₂ (Uᵥ), Uᵥ being a total number of valid port numbers, number of configured antenna muting patterns, or number of valid resource parameters.

Clause 22. The method of any of the preceding clauses, wherein a RS resource of the one or more RS resources is associated with multiple patterns, and wherein the CSI report is transmitted based on a predefined pattern when the first signaling does not indicate a selection of at least one of the multiple patterns.

Clause 23. The method of any of the preceding clauses, wherein the first signaling includes an indication for a group of wireless devices including the wireless device.

Clause 24. The method of clause 23, further comprising: receiving a higher layer signaling, wherein the indication is transmitted in a block of a downlink control information (DCI), wherein a starting position or length of the block is determined based on the higher layer signaling.

Clause 25. The method of any of the preceding clauses, wherein the one or more CSI reports includes a first CSI report and a second CSI report, wherein the first CSI report includes a rank indicator (RI), a precoding matrix indicator (PMI), and a channel quality information (CQI), and wherein the second CSI report does not include PMI.

For example, the solutions listed below may be used by network implementations (e.g., BS 120 of FIG. 1) for receiving channel state information reporting as described herein.

Clause 26. A method of wireless communication comprising: transmitting, by a network node, a control signaling that includes one or more channel state information (CSI) report configurations associated with one or more reference signal (RS) resources; transmitting, by the network node, a first signaling; and receiving, from a wireless device, one or more CSI reports according to the first signaling and the one or more CSI report configurations.

Clause 27. The method of clause 26, wherein the first signaling indicates at least one of the following information: a bitmap; {N1, N2}, wherein N1 is associated with on a number of ports in a first dimension and N2 is associated with a number of ports in a second dimension; a port index set; a number of CSI reports; a number of antenna muting patterns; a number of RS resource associated with a CSI report configuration; a number of PUCCH resources associated with a CSI report configuration; a power offset; a scaling factor; a codebook configuration; or a resource parameter.

Clause 28. The method of clause 26 or 27, wherein the resource parameter includes at least one of: a number of ports, an indication of a port index, a power offset, a resource set identifier, a resource setting identifier, a resource identifier a transmission configuration indicator (TCI), a code division multiplexing (CDM) type, a resource mapping, a CDM group index, a frequency domain resource, a time domain resource, or a group index.

Clause 29. The method of any of clauses 26-28, wherein the information is indicated by a second bitmap, a codepoint, or an index.

Clause 30. The method of clause 29, wherein the information is indicated by the second bitmap, wherein each bit of the second bitmap is associated with a respective antenna muting pattern, set of port indices, or resource parameter, and wherein a value of each bit indicates whether the respective antenna muting pattern, the set of port indices, or the resource parameter is selected.

Clause 31. The method of any of clauses 25-30, wherein the information indicated in the first signaling is applied following a delay, wherein the information is applied when at least one of occurs: a CSI is calculated based on indicated ports, the power offset, or the resource parameter; the indicated ports or the one or more RS resources are activated; or the one or more CSI reports are performed according to the one or more CSI report configurations and the information.

Clause 32. The method of clause 31, wherein the delay is determined based on at least one of the following: Z, Z′, a predefined value, T_{switch}, a higher layer signaling, UE capability, K0, K2, or an offset.

Clause 33. The method of any clauses 26-32, wherein the one or more RS resources comprises at least one of: a set of resources or a resource setting.

Clause 34. The method of any of clauses 26-33, wherein the first signaling indicates a bitmap that indicates one or more ports associated with the one or more CSI reports.

Clause 35. The method of clause 34, wherein each bit in the bitmap indicates a first state of a first port index, and wherein a second state of a second port index is the same as the first state of the first port index.

Clause 36. The method of clause 34 or 35, wherein each bit in the bitmap indicates a pair of port indices.

Clause 37. The method of clause 36, wherein the ports in the pair have different polarization directions.

Clause 38. The method of clause 36 or 37, wherein a difference between the port indices in the pair is equal to M/2, wherein Mis a number of ports associated with the one or more RS resources.

Clause 39. The method of any of clauses 34-38, wherein each bit in the bitmap is associated with A*2 port indices, A being a positive integer.

Clause 40. The method of any of clauses 34-39, wherein a bit in the bitmap is associated with a group of port indices, wherein port indices of the group of port indices comprise an arithmetic sequence.

Clause 41. The method of any of clauses 34-40, wherein a first half of the bitmap has the same values as a second half of the bitmap.

Clause 42. The method of any of clauses 26-41, wherein the first signaling indicates N ports, N being a positive integer, and wherein the N ports are selected based on the value of N and a predefined rule.

Clause 43. The method of any of clauses 26-42, wherein the first signaling indicates a set {N1, N2}, wherein N1 is associated with a number of ports in a first dimension and N2 is associated with a number of ports in a second dimension, and wherein port indices associated with the one or more CSI reports are selected based on the set {N1, N2}.

Clause 44. The method of any of clauses 26-43, further comprising: transmitting, via higher layer signaling, one or more muting pattern configurations, wherein the one or more muting pattern configurations comprise at least one of: a bitmap, {N1,N2}, wherein N1 is associated with a number of ports in a first dimension and N2 is associated with a number of ports in a second dimension, a port index set, a number of value, a power offset, a scaling factor, a resource parameter.

Clause 45. The method of any of clauses 26-44, further comprising: transmitting one or more muting pattern configurations, wherein the one or more muting pattern configurations includes (1) a first muting pattern configuration indicating a first number of valid or activated ports, and (2) a second muting pattern configuration indicating a second number of valid or activated ports, wherein the second number is less than the first number, and wherein ports not indicated as valid or activated by the first muting pattern configuration are not indicated as valid or activated by the second muting pattern configuration.

Clause 46. The method of any of clauses 26-45, wherein a first CSI report configuration of the one or more CSI report configurations is associated with one or more RS resources, wherein the first signaling includes a field indicating a port number, an antenna muting pattern, or a resource parameter associated with one of the one or more RS resources, and wherein a length of the field is based on log₂ (Uᵥ), Uᵥ being a total number of valid port numbers, a number of antenna muting patterns, or a number of valid resource parameters.

Clause 47. The method of any of clauses 26-46, wherein a RS resource of the one or more RS resources is associated with multiple patterns, and wherein the CSI report is transmitted based on a predefined pattern when the first signaling does not indicate a selection of at least one of the multiple patterns.

Clause 48. The method of any of clauses 26-47, wherein the first signaling includes an indication for a group of wireless devices including the wireless device.

Clause 49. The method of clause 48, further comprising: transmitting a higher layer signaling, wherein the indication is transmitted in a block of a downlink control information (DCI), wherein a starting position or length of the block is determined based on the higher layer signaling.

Clause 50. The method of any of clauses 26-49, wherein the one or more CSI reports includes a first CSI report and a second CSI report, wherein the first CSI report includes a rank indicator (RI), a precoding matrix indicator (PMI), and a channel quality information (CQI), and wherein the second CSI report does not include PMI.

For example, the solutions listed below may be used by an apparatus (e.g., apparatus 1000 of FIG. 10) or by a computer-readable medium as described herein.

Clause 51. An apparatus for wireless communication comprising a processor configured to implement the method of any of clauses 1 to 50.

Clause 52. A computer readable medium having code stored thereon, the code when executed by a processor of a computing system, causing the computing system to implement a method recited in any of clauses 1 to 50.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

Conjunctive language such as the phrase “at least one of X, Y and Z,” unless specifically stated otherwise, is understood with the context as used in general to convey that an item, term, etc. may be either X, Y or Z, or any combination thereof. Thus, such conjunctive language is not generally intended to imply that certain embodiments require at least one of X, at least one of Y and at least one of Z to each be present. Further, use of the phrase “at least one of X, Y or Z” as used in general is to convey that an item, term, etc. may be either X, Y or Z, or any combination thereof.

Only a few implementations and examples are described, and other implementations, enhancements, and variations can be made based on what is described and illustrated in this disclosure.

1. A method of wireless communication comprising:
receiving, by a wireless device, a control signaling that includes one or more channel state information (CSI) report configurations associated with one or more reference signal (RS) resources;
receiving, by the wireless device, a first signaling; and
transmitting, to a network node, one or more CSI reports according to the first signaling and the one or more CSI report configurations.

2. The method of claim 1, wherein the first signaling indicates at least one of the following information:
a bitmap; {N1, N2}, wherein N1 is associated with a number of ports in a first dimension and N2 is associated with a number of ports in a second dimension;
a port index set; a number of CSI reports; a number of antenna muting patterns;
a number of RS resource associated with a CSI report configuration;
a number of PUCCH resources associated with a CSI report configuration;
a power offset;
a scaling factor;
a codebook configuration; or
a resource parameter.

3. The method of claim 2, wherein the resource parameter includes at least one of:
a number of ports, an indication of a port index, a power offset, a resource set identifier, a resource setting identifier, a resource identifier a transmission configuration indicator (TCI), a code division multiplexing (CDM) type, a resource mapping, a CDM group index, a frequency domain resource, a time domain resource, or a group index.

4. The method of claim 2, wherein the information is indicated by a second bitmap, a codepoint, or an index.

5. The method of claim 4, wherein the information is indicated by the second bitmap, wherein each bit of the second bitmap is associated with a respective antenna muting pattern, set of port indices, or resource parameter, and
wherein a value of each bit indicates whether the respective antenna muting pattern, the set of port indices, or the resource parameter is selected.

6. The method of claim 2, wherein the information indicated in the first signaling is applied following a delay, wherein applying the information includes at least one of:
calculating a CSI based on indicated ports, the power offset, or the resource parameter; activating the indicated ports or the one or more RS resources; or
performing the one or more CSI reports according to the one or more CSI report configurations and the information.

7. (canceled)

8. (canceled)

9. The method of claim 1, wherein the first signaling indicates a bitmap that indicates one or more ports associated with the one or more CSI reports.

10. The method of claim 9, wherein each bit in the bitmap indicates a first state of a first port index, and wherein a second state of a second port index is the same as the first state of the first port index.

11. The method of claim 9, wherein each bit in the bitmap indicates a pair of port indices, and the ports in the pair have different polarization directions.

12. (canceled)

13. The method of claim 11, wherein a difference between the port indices in the pair is equal to M/2, wherein M is a number of ports associated with the one or more RS resources.

14-16. (canceled)

17. The method of claim 1, wherein the first signaling indicates N ports, N being a positive integer, and wherein the N ports are selected based on the value of N and a predefined rule.

18. The method of claim 1, wherein the first signaling indicates a set {N1, N2}, wherein N1 is associated with a number of ports in a first dimension and N2 is associated with a number of ports in a second dimension, and wherein port indices associated with the one or more CSI reports are selected based on the set {N1, N2}.

19. The method of claim 1, further comprising:
receiving, via higher layer signaling, one or more muting pattern configurations, wherein the one or more muting pattern configurations comprise at least one of: a bitmap, {N1,N2}, wherein N1 is associated with a number of ports in a first dimension and N2 is associated with a number of ports in a second dimension, a port index set, a number of value, a power offset, a scaling factor, a resource parameter.

20. The method of claim 1, further comprising:
receiving one or more muting pattern configurations, wherein the one or more muting pattern configurations includes (1) a first muting pattern configuration indicating a first number of valid or activated ports, and (2) a second muting pattern configuration indicating a second number of valid or activated ports,
wherein the second number is less than the first number, and
wherein ports not indicated as valid or activated by the first muting pattern configuration are not indicated as valid or activated by the second muting pattern configuration.

21. The method of claim 1, wherein a first CSI report configuration of the one or more CSI report configurations is associated with one or more RS resources,
wherein the first signaling includes a field indicating a port number, an antenna muting pattern, or a resource parameter associated with one of the one or more RS resources, and
wherein a length of the field is based on log₂ (Uᵥ), Uᵥ being a total number of valid port numbers, a number of configured antenna muting patterns or a number of valid resource parameters.

22-25. (canceled)

26. A method of wireless communication comprising:
transmitting, by a network node, a control signaling that includes one or more channel state information (CSI) report configurations associated with one or more reference signal (RS) resources;
transmitting, by the network node, a first signaling; and
receiving, from a wireless device, one or more CSI reports according to the first signaling and the one or more CSI report configurations.

27-50. (canceled)

51. An apparatus for wireless communication comprising a processor configured to implement the method of claim 1.

52. A non-transitory computer readable medium having code stored thereon, the code when executed by a processor of a computing system, causing the computing system to implement the method of claim 1.

53. An apparatus for wireless communication comprising a processor configured to implement the method of claim 26.

54. A non-transitory computer readable medium having code stored thereon, the code when executed by a processor of a computing system, causing the computing system to implement the method of claim 26.
